(19) United States
(12) Patent Application Publication
(10) Pub. No.: US 2010/0256977 A1
(43) Pub. Date: Oct. 7, 2010

(54) MAXIMUM ENTROPY MODEL WITH CONTINUOUS FEATURES

(75) Inventors: Dong Yu, Kirkland, WA (US); Li Deng, Redmond, WA (US); Alejandro Acero, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/416,161

(22) Filed: Apr. 1, 2009

(51) Int. Cl. G10L 15/00

(52) U.S. Cl. 704/240; 704/E15.001

(57) ABSTRACT

Described is a technology by which a maximum entropy (MaxEnt) model, such as used as a classifier or in a conditional random field or hidden conditional random field that embed the maximum entropy model, uses continuous features with continuous weights that are continuous functions of the feature values (instead of single-valued weights). The continuous weights may be approximated by a spline-based solution. In general, this converts the optimization problem into a standard log-linear optimization problem without continuous weights at a higher-dimensional space.

### BACKGROUND

Many types of data are classified based on classifiers trained from labeled training data. A maximum entropy (MaxEnt) model that inputs features extracted from the data is often an effective mechanism for performing the classification. For example, natural language processing, which is generally directed towards recognizing speech or handwriting into text and generating speech from text, is one field in which the maximum entropy model with moment constraints (a typical type of constraints used in the maximum entropy model) on binary features has been shown to be effective.

This model is not as successful when non-binary (e.g., continuous) features are used, however. Because many types of data (such as acoustical and handwriting data) have continuous features, to improve the model's performance, quantization techniques such as bucketing (or binning) have been proposed to convert the continuous features into binary features.

However, such quantization techniques provide only a limited performance improvement (e.g., in classification accuracy) due to various limitations. For example, a coarse quantization may introduce large quantization errors and cancel any gain obtained from using the converted binary features. Conversely, a fine quantization may significantly increase the number of model parameters and introduce parameter estimation uncertainties.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a maximum entropy model, such as used as a classifier, uses a continuous weight for each continuous feature, in which the continuous weight is a function of that continuous feature's value (instead of a fixed weight for all feature values, for example). For example, when continuous feature values corresponding to continuous features of input data are received, the maximum entropy model uses the value of each continuous feature in applying (e.g., multiplying) a continuous weight to that continuous feature value.

In one aspect, the continuous weight comprises is determined by using a piece-wise function to approximate the corresponding continuous weight. For example, the approximation may be accomplished by spline interpolation. In general, the piece-wise function may be used to map each continuous feature value into more feature values.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for training to obtain classification data used in classification by a maximum entropy classifier that is based upon continuous weights for continuous features.

FIG. 2 is a block diagram showing example components for classifying input data by a maximum entropy classifier that is based upon continuous weights for continuous features.

FIGS. 3 and 4 are representations of matrices that may be used in determining a continuous weight value corresponding to a continuous feature value.

FIG. 5 is a flow diagram showing example steps taken to classify input data using maximum entropy classifier that is based upon continuous weights for continuous features.

FIG. 6 is a flow diagram showing example steps taken to classify input data using maximum entropy classifier that is based upon expanding a continuous feature into a plurality of features.

FIG. 7 shows an illustrative example of a computing device into which various aspects of the present invention may be incorporated.

### DETAILED DESCRIPTION

Various aspects of the technology described herein are generally directed towards using a maximum entropy model to classify data that includes continuous features. In one aspect this is accomplished by using a feature weight that is not a fixed value, but rather is a function of the feature value that changes as the feature value changes.

While classification, such as of handwriting data, is described as one use of a maximum entropy model, it is understood that this is only an example. Classification and other uses for a maximum entropy model (or models such as conditional random field and hidden conditional random field that embed the maximum entropy model) are considered, as well as processing any type of data having continuous and/or a mix of continuous and binary features. Examples of applications that may benefit from a continuous feature-capable maximum entropy model include system combination, e.g., where classification scores such as posterior probabilities from different systems can be combined to achieve better accuracy, and confidence calculation, where acoustic model (AM) and language model (LM) scores can be combined with other features to estimate the confidence. Another example includes call routing, where counts or frequency of the unigram/bigram can be used to determine where to route a call. Document classification is yet another example, where counts or frequency of the unigram/bigram can be used to determine a document's type. Conditional random field (CRF) and hidden CRF (HCRF) based acoustic modeling, where cepstrum, language model score and other features such as speech rate can embed the maximum entropy model and be used to build a conditional speech recognition model. Thus, the technology described herein not only applies to a standard maximum entropy model, but also to all classes of models that have such a maximum entropy model as their component or components. Examples of such larger models include a Markov maximum entropy model, a conditional random field model, a hidden conditional random field model, a Markov random field model, a Boltzmann machine, partially observed maximum entropy discrimination Markov networks, and so forth.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

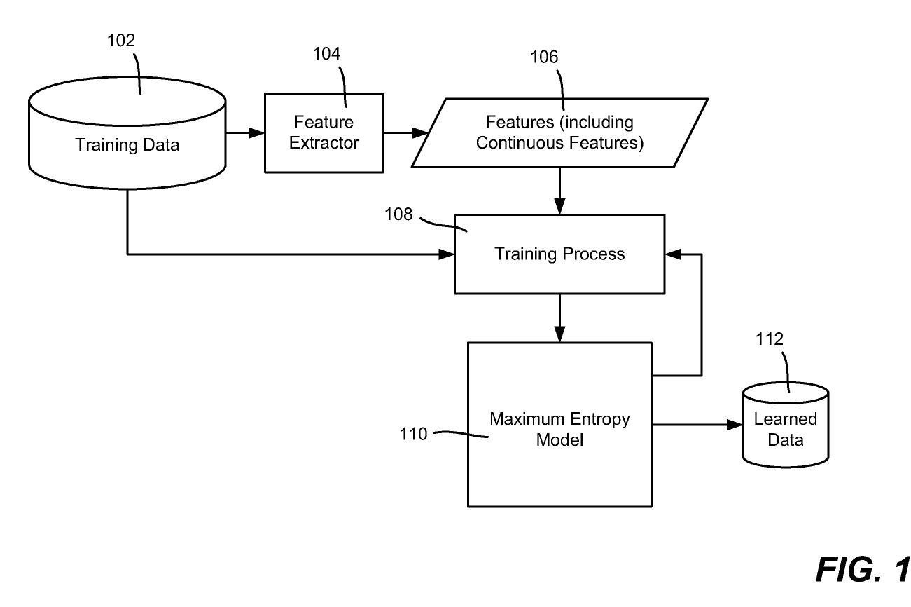

Turning to FIG. 1, there is shown a training environment, in which labeled training data 102 is used to train a maximum entropy model. Note that in general and as described below, the features of the data include continuous features, and the technology constrains on the distribution of the features rather than the moment (or additional moments, e.g., second order, third order moments) of features.

In general, a feature extractor 104 that is appropriate for the type of training data extracts features 106 from the training data 102, including continuous features, which may be a mix of continuous and binary features.

A training process 108 in conjunction with a maximum entropy model 110 uses the labeled training data to learn data 112 (e.g., parameters) for use in classification. Significantly, the learned data 112 include a feature weight for each continuous feature, which as described below, is not (ordinarily) a fixed weight, but rather a function of the continuous feature's value and thus changes for different values of its associated feature.

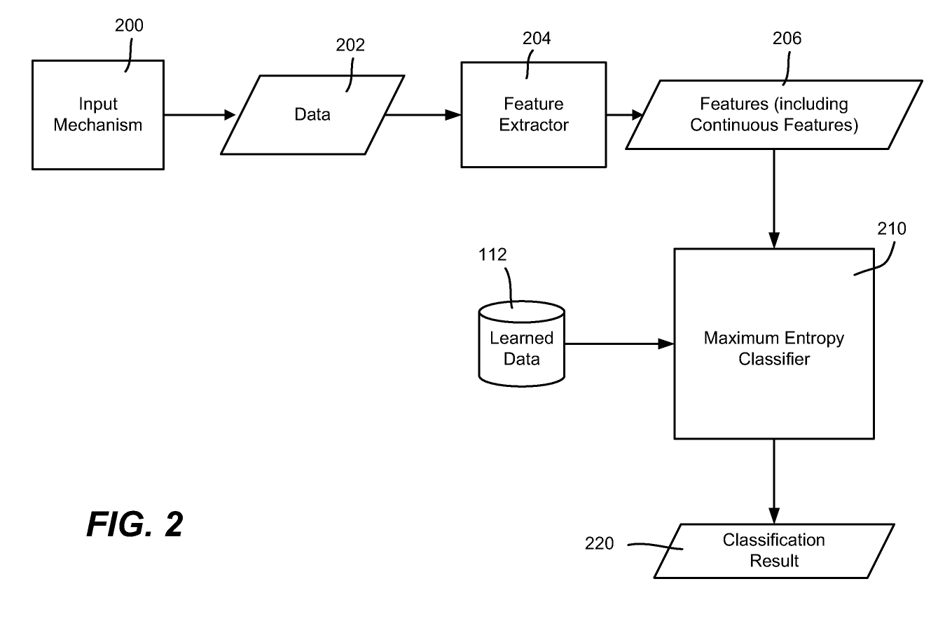

FIG. 2 exemplifies how once the data is learned, the maximum entropy model may be used as a classifier 210. In general, an input mechanism (which may receive speech, handwritten input, file data and so forth) provides data 202 to a feature extractor 204. As is known, the feature extractor is configured to extract features 206 relevant to the data being processed and corresponding to the training data/learned data 112, including continuous features. Using approximations of weights corresponding to the learned data 112 as described below, the maximum entropy classifier 210 provides a classification result based upon the input feature values.

By way of background, as mentioned above the maximum entropy model with moment constraints works well for binary features, but not as well for continuous features. As described herein, this is generally because the moment constrains on binary features are strong while the moment constraints on continuous features are weak. By way of example, consider a random process that produces an output value y from a finite set Y for some input value x. Assume that a training set (x₁,y₁), (x₂,y₂), . . . , (x_{N},y_{N}) with N samples is given. The training set can be represented with the empirical probability distribution

$$\tilde{p} ( x , y ) = \frac{number of times that ( x , y ) occurs}{N} . \qquad ( 1 )$$

A stochastic model can be constructed to accurately represent the random process that generated the training set \tilde{p}(x,y), where p(y|x) is the probability of outputting y by the model when x is given and assume that a set of constraints C is known either from the training data and/or from some previously obtained knowledge.

The known maximum entropy principle dictates that from all the probability distributions p(y|x) that accord with the constraints C, the distribution which is most uniform is selected. Mathematically, this corresponds to selecting the distribution that maximizes the entropy:

$$H ( p ) = - {\sum }_{x , y} \tilde{p} ( x ) p ( y \vert x ) log p ( y \vert x ) \qquad ( 2 )$$

over the conditional probability p(y|x).

With respect to moment constraints, assume that a set of M features fᵢ(x,y), i=1,. . . , M is available. The moment constraint requires that the moment of the features as predicted from the model should be the same as that observed from the training set. In most cases only the constraints on the first order moment:

Eₚ[fᵢ]=E_{\tilde{p}}[fᵢ], i=1, . . . M (3)

are used, where

$$\begin{matrix}{E}_{p} [ {f}_{i} ] = {\sum }_{x , y} \tilde{p} ( x ) p ( y \vert x ) {f}_{i} ( x , y ) \\ and & ( 4 ) \\ {E}_{\tilde{p}} [ {f}_{i} ] = {\sum }_{x , y} \tilde{p} ( x , y ) {f}_{i} ( x , y ) = {\sum }_{x , y} \tilde{p} ( x ) \tilde{p} ( y \vert x ) {f}_{i} ( x , y ) . & ( 5 )\end{matrix}$$

A property of the maximum entropy model with moment constraint is that its solution is in the log-linear form of:

$$\begin{matrix}p ( y \vert x ) = \frac{1}{{Z}_{λ} ( x )} exp ( {\sum }_{i} {λ}_{i} {f}_{i} ( x , y ) ) , \\ where & ( 6 ) \\ {Z}_{λ} ( x ) = {\sum }_{y} exp ( {\sum }_{i} {λ}_{i} {f}_{i} ( x , y ) ) & ( 7 )\end{matrix}$$

is a normalization constant to make sure Σ_{y}p(y|x)=1, and λ is chosen to maximize

$$Ψ ( λ ) = - {\sum }_{x} \tilde{p} ( x ) log {Z}_{λ} ( x ) + {\sum }_{i} {λ}_{i} {E}_{\tilde{p}} [ {f}_{i} ] . \qquad ( 8 )$$

Because this dual problem is an unconstraint convex problem, many known algorithms such as generalized iterative scaling (GIS), gradient ascent and conjugate gradient (e.g. L-BFGS) can be used to find the solution.

The maximum entropy principle basically states to not assume any additional structure or constraints other than those already imposed in the constraint set C. The appropriate selection of the constraints thus is a factor; in principle, all the constraints that can be validated by (or reliably estimated from) the training set or prior knowledge are included.

With the binary features where fᵢ(x,y)ε{0,1}, the moment constraint of equation (3) is a strong constraint since Eₚ[f]=p(f=1). In other words, constraining on the expected value implicitly constrains the probabilities that the feature takes values of 0 and 1. However, the moment constraint is relatively weak for continuous features. Constraining on the expected value does not mean much to the continuous features as many different distributions can yield the same expected value. In other words, much information carried in the training set is not used in the parameter estimation if only moment constraints are used for the continuous features. This is a reason that the maximum entropy model works well for binary features but not as well for non-binary features, especially the continuous features.

By way of example, consider a random process that generates 0 if xε{1,3}, and generates 1 if xε{2} and assume that there is a training set with the empirical distributions

$$\begin{matrix}\tilde{p} ( 1 , 0 ) = 0.25 , & \tilde{p} ( 1 , 1 ) = 0 , & \tilde{p} ( 2 , 0 ) = 0 , & \tilde{p} ( 2 , 1 ) = 0.5 \\ \tilde{p} ( 3 , 0 ) = 0.25 , & \tilde{p} ( 3 , 1 ) = 0 , & & \end{matrix} \qquad ( 9 )$$

and features

$${f}_{1} ( x , y ) = \{ \begin{matrix}x & if y = 0 \\ 0 & otherwise\end{matrix} \\ {f}_{2} ( x , y ) = \{ \begin{matrix}x & if y = 1 \\ 0 & otherwise\end{matrix} \qquad ( 10 )$$

Note that these features have same moment constraints since

E_{\tilde{p}}[f₁]=E_{\tilde{p}}[f₂]=1. (11)

However, they have very different distributions since

$$\tilde{p} ( {f}_{1} = 0 ) = 0.5 , \tilde{p} ( {f}_{2} = 0 ) = 0.5 , \\ \tilde{p} ( {f}_{1} = 1 ) = 0.25 , \tilde{p} ( {f}_{2} = 1 ) = 0 , \\ \tilde{p} ( {f}_{1} = 2 ) = 0 , \tilde{p} ( {f}_{2} = 2 ) = 0.5 , \\ \tilde{p} ( {f}_{1} = 3 ) = 0.25 , \tilde{p} ( {f}_{2} = 3 ) = 0. \qquad ( 12 )$$

This indicates that the moment constraint is not strong enough to distinguish between two different feature distributions and the resulting maximum entropy model performs poorly.

An approach to include stronger constraints for continuous features uses quantization techniques. In other words, to get a better statistical model, quantization techniques such as bucketing (or binning) have been proposed to convert the continuous (or multi-value) features to the binary features and enforce the constraints on the derived binary features. With bucketing, for example, a continuous feature fᵢ in the range of [l, h] can be converted into K binary features

$${f}_{ik} ( x , y ) = \{ \begin{matrix}1 & if y matches and x ∈ [ {l}_{k} , {h}_{k} ] \\ 0 & otherwise\end{matrix} \qquad ( 13 )$$

where kε{1,2, . . . , K}, and lₖ=hₖ₋₁=(k−1)(h−l)/K+l. Using bucketing essentially approximates the constraints on the distribution of the continuous features with the moment constraints on each segment. Including constraints at each segment reduces the feasible set of the conditional probabilities p(y|x) and forces the learned model to match the training set more closely.

Turning to a maximum entropy model with continuous features, in one aspect described herein, the weights associated with the continuous features are continuous weighting functions, instead of single values. However, as described below, this means that the optimization problem is no longer a log-linear problem, but a non-linear problem with continuous weighting functions as the parameters. In one implementation, this more complex optimization problem is solved by approximating the continuous weighting functions with spline-interpolations. More particularly, this converts the non-linear optimization problem into a standard log-linear problem at a higher-dimensional space, where each continuous feature in the original space is mapped into several features. With this transformation, existing training and testing algorithms for the maximum entropy model can be directly applied to this higher-dimensional space.

To illustrate that the weight for continuous features in the maximum entropy model should not be a single value but a continuous function, the quantization technique is extended to its extreme by increasing the number of buckets to an extreme. Note that the above-described bucketing approach may be modified so that:

$${f}_{ik} ( x , y ) = \{ \begin{matrix}\frac{{h}_{k} + {l}_{k}}{2} & if y matches and x ∈ [ {l}_{k} , {h}_{k} ] \\ 0 & otherwise\end{matrix} \qquad ( 14 )$$

With this reformation the features are still binary since each feature takes only one of two values. A difference this new feature construction approach causes compared to the original approach (in equation (13) below) is that the corresponding weights λᵢₖ learned are scaled down by (hₖ+lₖ)/2. As the number of buckets increases, the constraints are increased, the distribution of the continuous features is better described, and the quantization errors are reduced. However, increasing the number of buckets increases the number of weighting parameters λᵢₖ that are estimated, and increases the uncertainty of the constraints because the empirical expected values are now estimated with less training samples. In real applications, a compromise usually needs to be made to balance these two forces if bucketing is to be used.

Assuming an infinite number of samples in the training set, the number of buckets may be increased to any large number as desired. Under this condition:

$${lim}_{k \to ∞} {\sum }_{k} {λ}_{ik} {f}_{ik} ( x , y ) = {λ}_{i} ( {f}_{i} ( x , y ) ) {f}_{i} ( x , y ) \qquad ( 15 )$$

by noting that only one fᵢₖ(x,y) is non-zero for each (x,y) pair, where λᵢ(fᵢ(x,y)) is a continuous weighting function over the feature values. This equation indicates that for continuous features, continuous weights, instead of single weight values, will provide better results. In other words, a solution to the maximum entropy model has the form of:

$$p ( y \vert x ) = \frac{1}{{Z}_{λ} ( x )} exp ( \begin{matrix}{\sum }_{i ∈ \{ continuous \}} {λ}_{i} ( {f}_{i} ( x , y ) ) {f}_{i} ( x , y ) + \\ {\sum }_{j ∈ \{ binary \}} {λ}_{j} {f}_{j} ( x , y )\end{matrix} ) \qquad ( 16 )$$

Notwithstanding, There are difficulties in using continuous weights, including that this solution cannot be solved with the existing maximum entropy training and testing algorithms. Indeed, the model is no longer log-linear. Further, the constraints at each real-valued point are difficult to enforce since the number of training samples is usually limited. Thus, as described below, equation (16) may be converted into the standard log-linear form by approximating the continuous weights with a piece-wise function, such as a spline using spline interpolations.

Spline interpolation is a standard way of approximating continuous functions. While any type of spline may be used, two well-known splines are the linear spline and the cubic spline, because the values of these splines can be efficiently calculated.

The use of the cubic spline is described herein, which is smooth up to the second-order derivative. There are two typical boundary conditions for the cubic spline, namely one for which the first derivative is zero and one where the second derivative is zero. The spline with the latter boundary condition is usually called natural spline and is used herein.

Given K knots {(fᵢⱼ,λᵢⱼ)|j=1, . . . ,K; fᵢⱼ<fᵢ₍ⱼ₊₁₎} in the cubic spline with the natural boundary condition, the value λᵢ(fᵢ) of a data point fᵢ can be estimated as:

$${λ}_{i} ( {f}_{i} ) = a {λ}_{ij} + b {λ}_{i ( j + 1 )} + c \frac{{\partial }^{2} {λ}_{i}}{\partial {f}_{i}^{2}} {\vert}_{{f}_{i} = {f}_{ij}} + d \frac{{\partial }^{2} {λ}_{i}}{\partial {f}_{i}^{2}} {\vert}_{{f}_{i} = {f}_{i ( j + 1 )}} , \qquad ( 17 )$$

where

$$a = \frac{{f}_{i ( j + 1 )} - {f}_{i}}{{f}_{i ( j + 1 )} - {f}_{ij}} , b = 1 - a , \\ c = \frac{1}{6} ( {a}^{3} - a ) {( {f}_{i ( j + 1 )} - {f}_{ij} )}^{2} , d = \frac{1}{6} ( {b}^{3} - b ) {( {f}_{i ( j + 1 )} - {f}_{ij} )}^{2} \qquad ( 18 )$$

are interpolation parameters, and [fᵢⱼ,fᵢ₍ⱼ₊₁₎] is the section where the point fᵢ falls. λᵢ(fᵢ) can also be written into the matrix form

λᵢ(fᵢ)≅α^{T}(fᵢ)λᵢ (19)

where λᵢ=[λᵢ₁, . . . , λ_{iK}]^{T}, α^{T}(fᵢ)=e^{T}(fᵢ)+f^{T}(fᵢ)C⁻¹D is a vector,

$${e}^{T} ( {f}_{i} ) = [ \begin{matrix}0 & … & \underbrace{a}_{j} & \underbrace{b}_{J + 1} & … & 0\end{matrix} ] , \\ {f}^{T} ( {f}_{i} ) = [ \begin{matrix}0 & … & \underbrace{c}_{j} & \underbrace{d}_{J + 1} & … & 0\end{matrix} ] \\ c \qquad ( 20 )$$

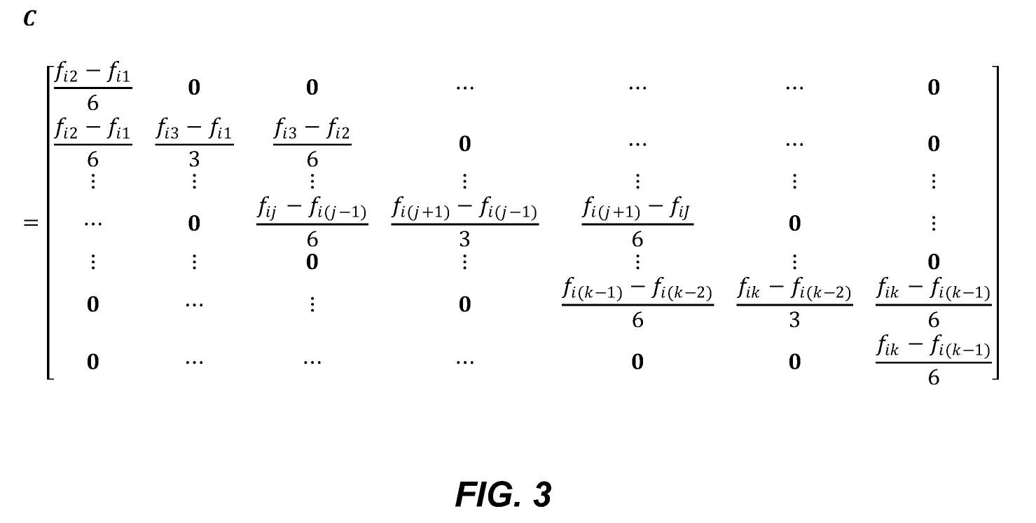

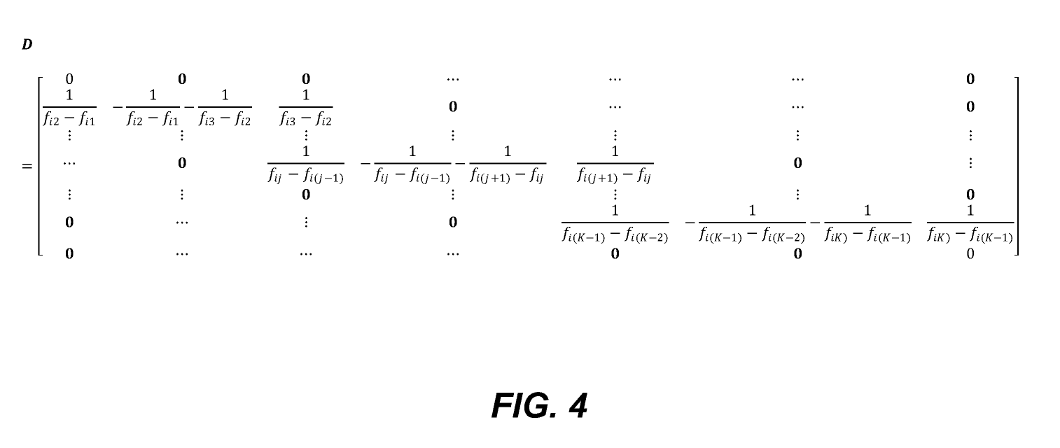

For space considerations, the matrices for C and D are shown in FIGS. 3 and 4, respectively.

If given K evenly distributed knots {(fᵢₖ,λᵢₖ)|k=1, . . . ,K} where h=fᵢₖ₊₁−fᵢₖ=fᵢⱼ₊₁−fᵢⱼ>0,∀j, kε{1, . . . ,K−1}, C and D (FIGS. 3 and 4) can be simplified as:

$$C = [ \begin{matrix}\frac{h}{6} & 0 & 0 & … & … & … & 0 \\ \frac{h}{6} & \frac{2 h}{3} & \frac{h}{6} & 0 & … & … & 0 \\ ⋮ & ⋮ & ⋮ & ⋮ & ⋮ & ⋮ & ⋮ \\ … & 0 & \frac{h}{6} & \frac{2 h}{3} & \frac{h}{6} & 0 & ⋮ \\ ⋮ & ⋮ & 0 & ⋮ & ⋮ & ⋮ & 0 \\ 0 & … & ⋮ & 0 & \frac{h}{6} & \frac{2 h}{3} & \frac{h}{6} \\ 0 & … & … & … & 0 & 0 & \frac{h}{6}\end{matrix} ]$$

$$D = [ \begin{matrix}0 & 0 & 0 & … & … & … & 0 \\ \frac{1}{h} & - \frac{2}{h} & \frac{1}{h} & 0 & … & … & 0 \\ ⋮ & ⋮ & ⋮ & ⋮ & ⋮ & ⋮ & ⋮ \\ … & 0 & \frac{1}{h} & - \frac{2}{h} & \frac{1}{h} & 0 & ⋮ \\ ⋮ & ⋮ & 0 & ⋮ & ⋮ & ⋮ & 0 \\ 0 & … & ⋮ & 0 & \frac{1}{h} & - \frac{2}{h} & \frac{1}{h} \\ 0 & … & … & … & 0 & 0 & 0\end{matrix} ]$$

Note that via equation (19):

$$\begin{matrix}{λ}_{i} ( {f}_{i} ) {f}_{i} ≅ {a}^{T} ( {f}_{i} ) {λ}_{i} {f}_{i} \\ = [ {a}^{T} ( {f}_{i} ) {f}_{i} ] {λ}_{i} \\ = {\sum }_{k} {λ}_{ik} [ {a}_{k} ( {f}_{i} ) {f}_{i} ] ,\end{matrix} \qquad ( 21 )$$

where αₖ(fᵢ) is the k-th element of α^{T}(fᵢ). Equation (21) indicates that the product of a continuous feature with its continuous weight can be approximated as a sum of the products of K transformed features in the form of αₖ(fᵢ)fᵢ with the corresponding K single-value weights. Equation (16) can thus be converted into

$$p ( y \vert x ) = \frac{1}{{Z}_{λ} ( x )} exp ( \begin{matrix}{\sum }_{i ∈ \{ continuous \} , k} {λ}_{ik} {f}_{ik} ( x , y ) + \\ {\sum }_{j ∈ \{ binary \}} {λ}_{j} {f}_{j} ( x , y )\end{matrix} ) , \qquad ( 22 )$$

where

fᵢₖ(x,y)=αₖ(fᵢ(x,y))fᵢ(x,y) (23)

depends on the original feature fi(x,y)and the locations of the knots, and is independent of the weights to be estimated.

Although the spline-approximation may carry errors, this approach has several advantages over using the continuous weights directly. First, it can better trade-off between the uncertainty of the constraints and the accuracy of the constraints since the weight value at each knot is estimated using not only the information at the knot but also information from many other samples in the training set. For example, when cubic-spline is used, each original continuous feature affects four features in the higher-dimensional space. Second, equation (22) is in the standard log-linear form and can be efficiently solved with existing algorithms for the maximum entropy model, except the algorithms that cannot handle negative values (e.g., GIS) since the derived features may be negative. Compared to the quantization approaches, this approach is more principled, has less approximation errors, and generally provides improved performance.

There are several practical considerations in using either bucketing or the approach described herein for continuous features. First, fᵢ(x,y)=0 essentially turns off the feature and thus the original continuous feature should not have values across 0. Second, both the bucketing approach and the above-described approach require the lower and higher bounds of the features and so the features are to be normalized into a fixed range. For example, the features f may be mapped into the range of [1 2] so that it also satisfies the first consideration. This can be done by first limiting the range of the features into [l h] with sigmoid function and then converting the features with f′=(f+h−2l )/(h-l).

Third, knots with both equal-distance and non-equal-distance can be used. Equal-distance knots are simpler and more efficient but less flexible. This problem can be alleviated by either increasing the number of knots or normalizing the features so that the distribution of the samples is close to uniform.

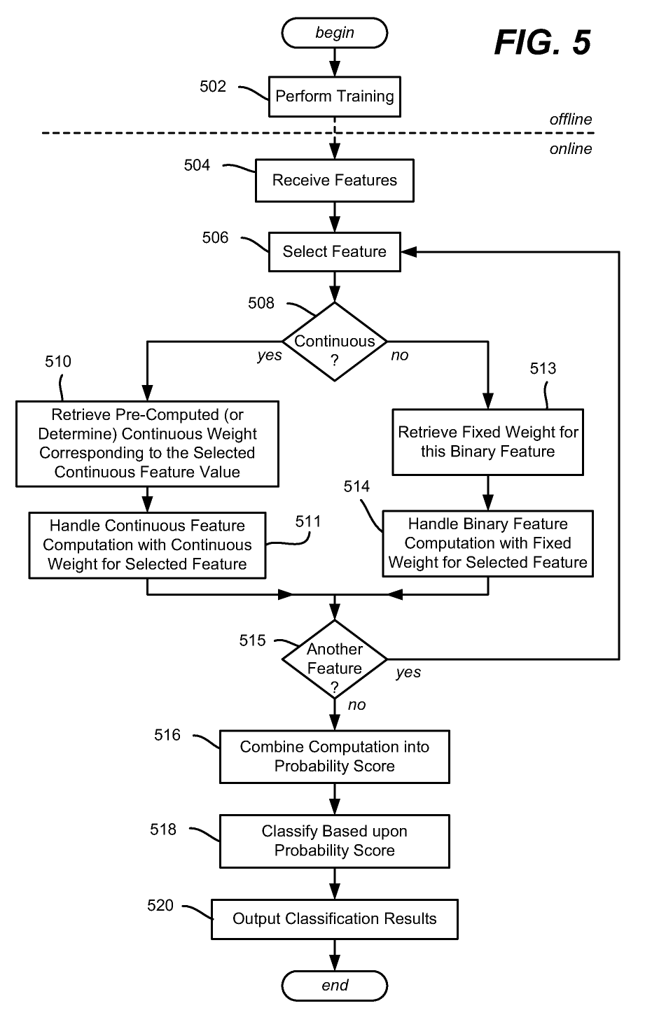

FIG. 5 exemplifies how classification may be performed once training (step 502) is completed and the model is ready to be used online.

Step 504 represents receiving features representative of some data to be classified, and step 506 selects one of the features. If the selected feature is a continuous feature as determined by step 508, then steps 510 and 511 are executed. Note that a binary feature is handled in a conventional way (with a fixed weight for all values of that particular feature) as exemplified via steps 513 and 514.

For a continuous feature, the weight, which is a function of the feature value as described above, needs to be determined. This may be pre-computed during training and cached, e.g., the stored approximated weight may be retrieved for that range of values into which the selected feature value falls. Alternatively, the weight may be computed dynamically as the feature value is retrieved, e.g., by applying the piece-wise function (such as the cubic spline) as described above to approximate the weight as needed. In any event, the weight is determined and used (e.g., multiplied by the feature value) as represented by step 511.

Step 515 repeats the process until all features have been processed. Step 516 combines (e.g., sums) the computed weighted feature value result into the calculation. Note that steps 515 and 516 may be reversed, e.g., the mathematical combination of the values may be performed as a running total instead of combining once all the values have been computed, for example.

When the features have been processed, step 518 classifies the input data based upon the combined weighted features, e.g., the computed probability score. Step 520 represents outputting the results.

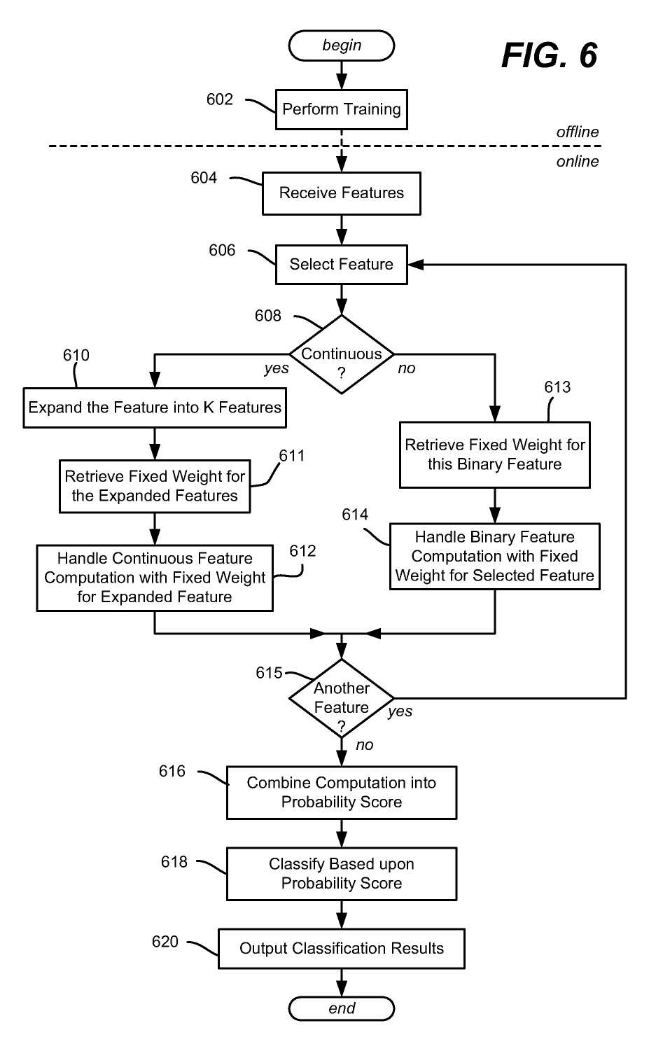

FIG. 6 is another alternative, which in general for continuous features expands each continuous feature into K features as shown in Equation (23) using the piece-wise function (such as the cubic spline), and then multiplying the fixed weights associated with each expanded feature. Note that steps 602-608 of FIG. 6 are analogous to steps 502-508 of FIG. 5, steps 613 and 614 are analogous to steps 513 and 514, and steps 615-620 are analogous to steps 515-520; these steps are thus not described again for purposes of brevity.

In this alternative, when a continuous feature is processed, step 610 expands the feature into a plurality of features (K features), and step 611 retrieves a fixed weight for each of these expanded features. Step 612 then handles the computation, e.g., multiplying each expanded feature by its corresponding fixed weight.

In summary, for continuous features, the weights are continuous functions instead of single values. The solution to the optimization problem can spread and expand each original feature into several features at a higher-dimensional space through a non-linear mapping. With this feature transformation, the optimization problem with continuous weights is converted into a standard log-linear feature combination problem, whereby existing maximum entropy algorithms can be directly used.

### Exemplary Operating Environment

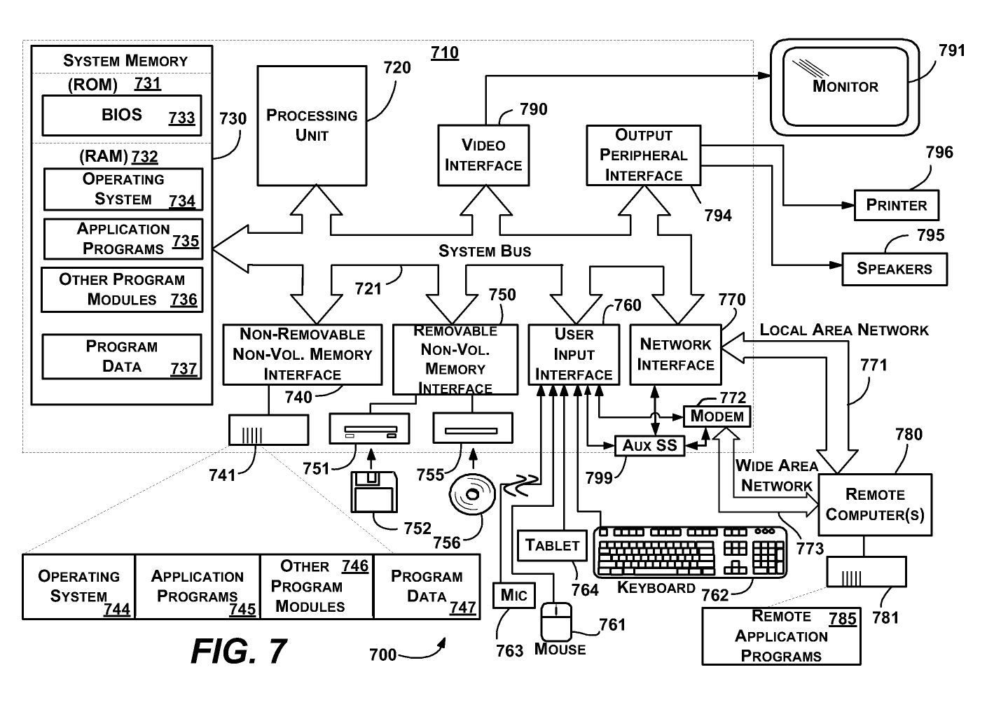

FIG. 7 illustrates an example of a suitable computing and networking environment 700 on which the examples of FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, receiving feature values for a set of data, including a feature value that is a continuous feature value, determining a corresponding weight for that feature value in which the weight corresponds to a function of the feature value, and using the continuous feature value and the corresponding weight in a maximum entropy model to classify the data into a classification result.

2. The method of claim 1 further comprising, extracting the feature values from the data.

3. The method of claim 1 wherein the feature values include another feature value that is a binary feature value, and further comprising, using the binary feature value in the maximum entropy model in a mathematical combination with the continuous feature value and the corresponding weight to classify the data into the classification result.

4. The method of claim 1 further comprising, learning the function of the feature value from training data.

5. The method of claim 1 further comprising, using a piece-wise function to approximate the corresponding weight.

6. The method of claim 1 further comprising approximating the corresponding weight by spline interpolation.

7. The method of claim 1 further comprising using a piece-wise function to map the continuous feature value into a plurality of feature values.

8. In a computing environment, a system comprising, an input mechanism that obtains input data, a feature extractor that processes the input data into feature values including at least one continuous feature value, and a maximum entropy model that for each continuous feature value, applies a continuous weight corresponding to that feature value to obtain a numerical result for that feature value.

9. The system of claim 8 wherein the input data comprises handwritten input data or acoustical input data.

10. The system of claim 8 wherein the maximum entropy model classifies the input data.

11. The system of claim 8 wherein the feature values include a binary feature value, and wherein the maximum entropy model applies a fixed weight corresponding to that binary feature value to obtain a numerical result for that binary feature value.

12. The system of claim 11 wherein the maximum entropy model combines the numerical result for each feature value with the numerical result for the binary feature value.

13. The system of claim 8 further comprising means for training the maximum entropy classifier.

14. The system of claim 8 further comprising means for determining the continuous weight by using a piece-wise function to approximate the continuous weight.

15. The system of claim 8 further comprising means for determining the continuous weight by approximating the continuous weight by spline interpolation.

16. The system of claim 8 wherein the maximum entropy model comprises a component or components of another model, including a conditional random field model, a hidden conditional random field model, a Markov maximum entropy model, a Markov random field model, a Boltzmann machine, or partially observed maximum entropy discrimination Markov networks.

17. One or more computer-readable media having computer-executable instructions, which when executed perform steps, comprising:
receiving feature values corresponding to features of input data, and
classifying the input data based upon the feature values via a maximum entropy classifier, including by determining whether each feature is a continuous feature or a binary feature, and
a) for each continuous feature, expanding the continuous feature into a plurality of features having values, retrieving a corresponding weight for each of the plurality of features, and using each expanded feature value in conjunction with its corresponding weight to obtain a weighted result for that that expanded feature, and
b) for each binary feature, determining a fixed weight that corresponds to that binary feature value, and using the fixed weight in conjunction with the binary feature value to obtain a weighted result for that binary feature, and
c) mathematically combining the weighted results for each continuous feature with the weighted results for each binary feature into a numerical result that is used to classify the input data.

18. The one or more computer-readable media of claim 16 having further computer-executable instructions comprising, training the maximum entropy classifier with training data.

19. The one or more computer-readable media of claim 16 wherein expanding the continuous feature comprises using a piece-wise function.

20. The one or more computer-readable media of claim 16 wherein the corresponding weight for each expanded feature is a fixed weight.
